(19) United States
(12) Patent Application Publication
(10) Pub. No.: US 2026/0242646 A1
(43) Pub. Date: Aug. 20, 2026

(54) TWO-COMPONENT THERMALLY CONDUCTIVE ADHESIVE

(71) Applicant: DDP SPECIALTY ELECTRONIC MATERIALS US, LLC, Wilmington, DE (US)

(72) Inventor: Sergio GRUNDER, Freienbach (CH)

(21) Appl. No.: 19/156,959

(22) PCT Filed: Mar. 1, 2024
(86) PCT No.: PCT/US2024/017979

§ 371 Date: Aug. 15, 2025

Related U.S. Application Data
(60) Provisional application No. 63/490,290, filed on Mar. 15, 2023.

(51) Int. Cl. C09J 175/12; C08G 18/10; C08G 18/50; C08K 3/22; C08K 5/521; C08K 5/5419; C08K 5/544; C09J 11/04; C09J 11/06; C09K 5/14

(52) U.S. Cl. CPC C09J 175/12; C08G 18/10; C08G 18/5024; C09J 11/04; C09J 11/06; C09K 5/14; C08K 2003/2227; C08K 5/521; C08K 5/5419; C08K 5/544

(57) ABSTRACT

Two-component thermally conductive adhesive with high conductive filler loading.

### BACKGROUND

There is a trend in the automotive industry to reduce the weight of the vehicles in the past decade. This trend has been driven by regulations to reduce CO₂ emission of vehicle fleets. In recent years, lightweight construction strategies have been further fueled by the increasing number of electrically driven vehicles. To provide for longer driving range, batteries with a high energy density are needed. All long range durable need adequate thermal management. To thermally connect battery cells or modules to a cooling unit, thermal interface materials or thermally conductive adhesives are needed.

Battery cells produce heat during charge and discharge. The cells should be kept in the right operating temperature (preferably 25-40° C.) to avoid efficiency losses, overheating, and dangerous runaway thermal reactions. For this reason, active cooling is commonly used. An efficient active cooling method involves pumping cooled water-glycol mixtures through channels that cool a bottom metal bottom on which the battery cells or modules are installed. Battery cells or arrays of cells can be bonded with thermal conductive adhesives directly to the cooling plate. This provides for good mechanical fixation and a thermal connection. To provide adequate conductivity, however, two-component thermally conductive adhesives generally must have a conductive filler loading of at least 70% by weight of each component. Particularly with the component of the adhesive that includes water, it is often difficult or impossible to achieve proper dispersion to allow for a pasteous formulation that can be mixed or cured with a second prepolymer component.

### SUMMARY

Disclosed is an uncured, two-part thermally conductive adhesive formulation having:
a) a first component comprising:
   i) 1% to 25% of a silane-terminated urethane prepolymer by weight of the first component;
   ii) at least 70% of a first thermally conductive filler by weight of the first component;
   iii) 0.1% to 5% of a first organofunctional silane by weight of the first component; and
   iv) 0% to 10% of a first plasticizer by weight of the first component; and
b) a second component comprising:
   i) 0.01% to 5% of water by weight of the second component;
   ii) at least 70% of a second thermally conductive filler by weight of the second component;
   iii) 0.1% to 5% of a polyetheramine by weight of the second component;
   iv) 0.1% to 5% of a second organofunctional silane by weight of the second component; and
   v) 1% to 20% of a second plasticizer by weight of the second component;

The uncured adhesive formulation is in the form of a kit in which the first and second components are not mixed prior to use. The components of the kit can be co-packaged, packaged separately, or sold together or separately.

Also described are cured adhesives made by mixing the first and second components of the adhesive formulation and allowing the mixture to cure, including processes to make individual components of the adhesive and processes for curing the two components. Similarly, articles are described that include the cured adhesive.

### DETAILED DESCRIPTION

To achieve a thermal conductivity greater than 1.5 W/mK, both parts of a two-component adhesive typically require at least 70% of a thermally conductive filler by weight of the component. In one embodiment, each component of the adhesive independently comprises 70% to 95% of a thermally conductive filler by weight of the component. In a further embodiment, each component of the adhesive independently comprises 75% to 90% of a thermally conductive filler by weight of the component. In a further embodiment, each component of the adhesive independently comprises 75% to 85% of a thermally conductive filler by weight of the component. In a further embodiment, each component of the adhesive independently comprises 80% to 85% of a thermally conductive filler by weight of the component.

A variety of thermally conductive fillers can be used. Examples include aluminum hydroxide, also known as aluminum trihydroxide (ATH), aluminum oxide, such as spherical aluminum oxide, and any combination thereof. ATH can be monomodal ATH powders or ATH powders having a multi-modal particle size distribution (e.g., bi-modal, tri-modal, and the like). When monomodal ATH powders are used, the average particle size can be 5-100 μm. When multi-modal ATH powders are used, the average particle size of the smallest particles can be less than about 10 μm, while the average particle size of the largest particles can be greater than about 50 μm. Additionally, the ATH powders can be surface treated with silane, titanate, carboxylates, etc.

In one embodiment, a combination of ATH and aluminum oxide such as spherical aluminum oxide can be used in the first component, the second component, or both. When this combination is used, the ratio of ATH to aluminum oxide can vary and can range for example from 0.1:99.9 to 99.9:0.1. In one embodiment, the ratio of ATH to aluminum hydroxide ranges from 80:20 to 20:80, e.g., 60:40 to 40:60.

### I. First Adhesive Component

### A. Silane Terminated Urethane Prepolymer

The first component of the two-part adhesive comprises a silane terminated urethane prepolymer. Silane terminated urethane prepolymers are urethane prepolymers in which some or all of the isocyanate groups are end capped with organosilanes. The silane terminated urethane prepolymers can be prepared by reacting an isocyanate functionalized silane with a polyol, or reacting an isocyanate functionalized silane with a hydroxyl terminated prepolymer, or reacting a nucleophile functionalized silane (e.g., amino silane, mercapto silane, etc.) with an isocyanate terminated prepolymer.

Examples of prepolymers include polyurethanes, polyureas, polyethers, polyesters, poly(meth)acrylates, polycarbonates, polystyrenes, polyamines or polyamides, polyvinyl esters, styrene/butadiene copolymers, polyolefins, polysiloxanes, and polysiloxane-urea/urethane copolymers. The silane terminated urethane prepolymers can have a weight-averaged molecular weight ranging from 200-5,000, 300-3,000, or 500-2,000, as determined by gel permeation chromatograpy (GPC).

Suitable silane terminated urethane prepolymers include any of those disclosed in EP 1924621 and U.S. Pat. Nos. 3,933,756; 5,756,751; 6,288,198; 6,545,087; 6,703,453; 6,809,170; 6,833,423; 6,844,413; 6,887,964; 6,998,459; 7,115,696; 7,465,778; 7,060,750; and 7,309,753, which are incorporated by reference for their teachings concerning silane terminated urethane prepolymers. Silane terminated urethane prepolymers also are available commercially.

In one embodiment, the first component comprises 1% to 25% of the silane terminated urethane prepolymer by weight of the first component. In a further embodiment, the first component comprises 5% to 25% of the silane terminated urethane prepolymer by weight of the first component. In a further embodiment, the first component comprises 5% to 15% of the silane terminated urethane prepolymer by weight of the first component. In a further embodiment, the first component comprises 8% to 12% of the silane terminated urethane prepolymer by weight of the first component. In a further embodiment, the first component comprises 8% to 10% of the silane terminated urethane prepolymer by weight of the first component.

### B. First Organofunctional Silane

The first adhesive component can comprise a first organofunctional silane. The first component can comprise 0.1% to 5% of the organofunctional silane by weight of the first component. The first organofunctional silane can be the same or different from the second organofunctional silane. In one embodiment, both silanes are the same. The organofunctional silane can function as a surface modifier for the thermally conductive filler. For example, the organofunctional silane can partially or completely cover the surface of the conductive filler particle. The conductive filler can include surface M-OH groups, where M is a metal atom, and the organofunctional silane can include a functional group that reacts with the M-OH group to form a direct or indirect bond between the surface modifier and M.

The surface of the conductive filler can be hydrophobized with the organofunctional silane. It will be appreciated that the organofunctional silane can be added to the filler before or after mixing the conductive filler with the matrix phase material. For example, the conductive filler can be coated or reacted with organofunctional silane prior to mixing the conductive filler and the matrix phase material. As another example, the organofunctional silane can be mixed with the matrix phase material to form a premix which is then combined with the conductive filler. As another example, the conductive filler and the matrix phase material can be mixed and then organofunctional silane can be added to the mixture.

In one embodiment, the first component comprises 0.1% to 5% of the organofunctional silane by weight of the second component. In a further embodiment, the first component comprises 0.5% to 3% of the organofunctional silane by weight of the first component. In a further embodiment, the first component comprises 0.5% to 1.5% of the organofunctional silane by weight of the first component.

A variety of organofunctional silanes can be used. In one embodiment, the organofunctional silane is an alkyl silane. In a further embodiment, the organofunctional silane has the following structure:

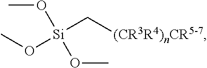

wherein n is an integer ranging from 0 to 24 and R³-R⁷ are independently hydrogen or optionally substituted C1-C4 alkyl. In a further embodiment, R³-R⁷ are independently hydrogen or unsubstituted C1-C4 alkyl. In a further embodiment, n is an integer ranging from 1 to 15, e.g., 2-14, 5-14, 8-14, or 10-14. Specific non-limiting examples include trimethoxy(methyl) silane, ethyltrimethoxysilane, trimethoxy (propyl) silane, butyltrimethoxysilane, trimethoxy (pentyl) silane, hexyltrimethoxysilane, heptyltrimethoxysilane, trimethoxy (octyl) silane, trimethoxy (nonyl) silane, decyltrimethoxysilane, trimethoxy (undecyl) silane, dodecyltrimethoxysilane, trimethoxy (tridecyl) silane, trimethoxy (tetradecyl) silane, trimethoxy (pentadecyl) silane, hexadecyltrimethoxysilane, or a combination thereof.

### II. Second Adhesive Component

In addition to the thermally conductive filler described above, the second component comprises water as a hardener. Water permits the hydrolysis of silane groups to form siloxanes on the prepolymer of the first component, which is how the two-part adhesive cures when the two components are mixed together. In one embodiment, the second component comprises 0.01% to 5% of water by weight of the second component. In a further embodiment, the second component comprises 0.1% to 2% of water by weight of the second component. In a further embodiment, the second component comprises 0.1% to 1% of water by weight of the second component. In a further embodiment, the second component comprises 0.1% to 0.5% of water by weight of the second component.

### A. Polyetheramine

The inventors surprisingly discovered that by including both a polyetheramine and an alkylsilane in the second adhesive component, significantly improved dispersion, low viscosity, and no phase separation was observed when mixing parts of the second component. Typically, high conductive filler levels (e.g., greater than 70%) can lead to poor dispersion and can make it difficult or impossible to get a pasteous formulation as demonstrated by the comparative examples below. The combination of the polyetheramine and the alkyl silane in the second component avoids these problems.

In one embodiment, the second component comprises 0.1% to 5% of the polyetheramine by weight of the second component. In a further embodiment, the second component comprises 0.5% to 3% of the polyetheramine by weight of the second component. In a further embodiment, the second component comprises 0.5% to 1.5% of the polyetheramine by weight of the second component. In a further embodiment, the second component comprises 0.5% to 1% of the polyetheramine by weight of the second component, e.g., about 1%.

The polyetheramine can be a di- or tri-amine. The amine groups can independently be secondary or primary. Generally, the polyetheramine can have a weight average molecular weight ranging from 200 to 6,000 g/mol. In one embodiment, the polyetheramine has a weight average molecular weight ranging from 1,000 to 5,000 g/mol. In a further embodiment, the polyetheramine has a weight average molecular weight ranging from 1,500 to 4,000 g/mol. In a further embodiment, the polyetheramine has a weight average molecular weight ranging from 2,000 to 3,500 g/mol. In a further embodiment, the polyetheramine has a weight average molecular weight ranging from 2,500 to 3,500 g/mol, e.g., about 3,000 g/mol.

The polyetheramine can have a backbone based on poly(alkylene oxide)diols, for example C2-C6 alkylene, C2-C4 alkylene, or C3 alkylene. The backbone can be based on a polyether of propylene glycol. In one embodiment, the polyetheramine has at least one residue having the formula:

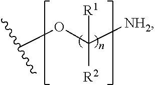

wherein n is an integer ranging from 1 to 5, and R¹ and R² are independently optionally substituted C1-C4 alkyl. In a further embodiment, at least one of R¹ or R² is hydrogen. In a further embodiment, R¹ is hydrogen and R² is optionally substituted C1-C4 alkyl, e.g., optionally substituted methyl, ethyl, propyl, or butyl.

In one embodiment, the polyetheramine can be a triamine having primary amines accounting for greater than 90% of amine groups and a backbone based on a polyether of propylene glycol. A non-limiting examples is a polyetheramine having the structure:

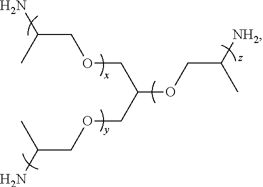

wherein x, y, and z total an integer ranging from 6 to 90. Any aliphatic carbon in the above triamine structure can also be substituted with a C1-C4 alkyl group such as a methyl group. One specific example is a triamine in which x, y, and z in the above triamine structure total to about 50, which also has the following characteristics:

Typical properties

| Property | Value | |
|---|---|---|
| Primary amine, | >97 | |
| % of total amine | | |
| Total acetylatables | 0.96-1.06 | meq/g |
| Total amine | 0.90-0.98 | meq/g |
| Water | <0.25 | wt % |
| Amine hydrogen | 530 | g/eq |
| equivalent | | |
| Viscosity @ 25° C. | 367 | cSt |
| Density @ 25° C. | 0.996 | ml |

### B. Second Organofunctional Silane

The polyetheramine can be present in the second component along with 0.1% to 5% of an organofunctional silane (i.e., the second organofunctional silane) by weight of the second component. The second organofunctional silane can be the same or different from the first organofunctional silane. In one embodiment, both silanes are the same. In one embodiment, the second component comprises 0.1% to 5% of the organofunctional silane by weight of the second component. In a further embodiment, the second component comprises 0.5% to 3% of the organofunctional silane by weight of the second component. In a further embodiment, the second component comprises 0.5% to 1.5% of the organofunctional silane by weight of the second component.

A variety of organofunctional silanes can be used. In one embodiment, the organofunctional silane is an alkyl silane. In a further embodiment, the organofunctional silane has the following structure:

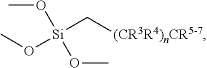

wherein n is an integer ranging from 0 to 24 and R³-R⁷ are independently hydrogen or optionally substituted C1-C4 alkyl. In a further embodiment, R³-R⁷ are independently hydrogen or unsubstituted C1-C4 alkyl. In a further embodiment, n is an integer ranging from 1 to 15, e.g., 2-14, 5-14, 8-14, or 10-14. Specific non-limiting examples include trimethoxy(methyl) silane, ethyltrimethoxysilane, trimethoxy (propyl) silane, butyltrimethoxysilane, trimethoxy (pentyl) silane, hexyltrimethoxysilane, heptyltrimethoxysilane, trimethoxy (octyl) silane, trimethoxy (nonyl) silane, decyltrimethoxysilane, trimethoxy (undecyl) silane, dodecyltrimethoxysilane, trimethoxy (tridecyl) silane, trimethoxy (tetradecyl) silane, trimethoxy (pentadecyl) silane, hexadecyltrimethoxysilane, or a combination thereof.

### III. Other Additives

The first component, the second component, or both, can include a variety of other additives such as plasticizers, one or more catalysts to promote the reaction of water with the silane-terminated urethane prepolymer, optionally a color paste, optionally additional fillers such as magnesium or calcium carbonates.

### A. Plasticizer

In one embodiment, the first component or the second component can comprise a first or second plasticizer, respectfully. In a further embodiment, the first component does not comprise a plasticizer. In a further embodiment, the first component comprises 0% to 10% of a first plasticizer by weight of the first component. In a further embodiment, the first component comprises 1% to 8% of the first plasticizer by weight of the first component. In a further embodiment, the first component comprises 6% to 6% of the first plasticizer by weight of the first component.

In one embodiment, the second component comprises 1% to 20% of a second plasticizer by weight of the second component. The first plasticizer, when present in the first component, can be the same or different from the second plasticizer. In one embodiment, the second component comprises 3% to 15% of the second plasticizer by weight of the second component. In a further embodiment, the second component comprises 5% to 10% of the second plasticizer by weight of the second component.

In one embodiment, the plasticizer can have a weight average molecular weight of 2,000 g/mol or less, e.g., 1,000 g/mol or less, 800 g/mol or less, or 600 g/mol or less. The plasticizer will generally be a liquid at a temperature of about 100° C. In general, suitable plasticizers include ester derivatives of acids and anhydrides such as adipic acid, azelaic acid, benzoic acid, citric acid, dimer acids, fumaric acid, isobutyric acid, isophthalic acid, lauric acid, linoleic acid, maleic acid, maleic anyhydride, melissic acid, myristic acid, oleic acid, palmitic acid, phosphoric acid, phthalic acid, ricinoleic acid, sebacic acid, stearic acid, succinic acid, 1,2-benzenedicarboxylic acid, and the like, and mixtures thereof. Also suitable are epoxidized oils, glycerol derivatives, paraffin derivatives, sulfonic acid derivatives, and the like, and mixtures thereof.

Specific examples of such plasticizers include diethylhexyl adipate, heptyl nonyl adipate, diisodecyl adipate, the adipic acid polyesters, dicapryl adipate, dimethyl azelate, diethylene glycol dibenzoate and dipropylene glycol dibenzoate, polyethylene glycol dibenzoate, 2,2,4-trimethyl-1,3-pentanediol monoisobutyrate benzoate, 2,2,4-trimethyl-1,3-pentanediol diisobutyrate, methyl (or ethyl, or butyl) phthalyl ethyl glycolate, triethyl citrate, dibutyl fumarate, 2,2,4-trimethyl-1,3-pentanediol diisobutyrate, methyl laurate, methyl linoleate, di-n-butyl maleate, tricapryl trimellitate, heptyl nonyl trimellitate, triisodecyl trimellitate, triisononyl trimellitate, isopropyl myristate, butyl oleate, methyl palmitate, tricresyl phosphate, tris(2-ethylhexyl)phosphate, dimethyl phthalate, diethyl phthalate, dibutyl phthalate, diisobutyl phthalate, di-2-ethylhexyl phthalate, octyl decyl phthalate, diisodecyl phthalate, heptyl nonyl phthalate, diundecyl phthalate, ditridecyl phthalate, dicyclohexyl phthalate, diphenyl phthalate, butyl benzyl phthalates such as the n-butylbenzyl ester of o-phthalic acid, isodecyl benzyl phthalate, alkyl(C7/C9)benzyl phthalate, dimethoxyethyl phthalate, 7-(2,6,6,8-tetramethyl-4-oxa-3-oxo-nonyl)benzyl phthalate, di-2-ethylhexyl sebacate, butyl ricinoleate, dimethyl sebacate, methyl stearate, diethyl succinate, the butyl phenylmethyl ester of 1,2-benzenedicarboxylic acid, epoxidized linseed oil, glycerol triacetate, chloroparaffins having about 40% to about 70% Cl, o,p-toluenesulfonamide, N-ethyl p-toluene sulfonamide, N-cyclohexyl p-toluene sulfonamide, sulfonamide-formaldehyde resin, and mixtures thereof.

Other suitable plasticizers known to those skilled in the art include castor oil, aromatic petroleum condensate, partially hydrogenated terphenyls, silicone plasticizers such as dimethicone copolyol esters, dimethiconol esters, silicone carboxylates, guerbet esters, and the like, alone or as mixtures with other plasticizers.

In one embodiment, either of both plasticizers can be a phosphate such as a tri-alkyl phosphate, e.g., tri-octyl phosphates. In a further embodiment, the first plasticizer, when present, or the second plasticizer, has the following structure:

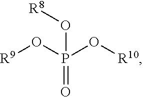

wherein R⁸-R¹⁰ are independently optionally substituted branched or linear C1-C24 alkyl. In some embodiments, R⁸-R¹⁰ are the same. In a further embodiment, at least one of R⁸-R¹⁰ is branched. In a further embodiment, R⁸-R¹⁰ are independently optionally substituted branched or linear C4-C18 alkyl, e.g., C6-C16, or C8-C16 alkyl. In a specific embodiment at least one of (or all of) R⁸-R¹⁰ are 3-methylheptyl, i.e., a tris(2-ethylhexyl)phosphate plasticizer.

### B. Adhesion Promoter

Some embodiments of the adhesive formulation include an adhesion promoter in the first component, the second component, or both. When both components include an adhesion promoter, the promoter can be the same or different. The adhesion promoter can be for example, a silane, an epoxy silane, an aminosilane, or a combination thereof. The adhesion promoter can constitute, for example, 0.1% to 3% of the total weight of either component. In some embodiments, the adhesion promoter can be present in either component in an amount ranging from 0.1% to 1% by weight of the isocyanate component, e.g., 0.2% to 0.5%.

Adhesion promoters include compounds with at least one functional group that has an attractive force to the surface of a desired substrate, a cured adhesive to be applied to the substrate, or both. Examples of adhesion promoters include a titanate, carboxylated branched or linear PEI, and silane compounds. Non-limiting examples include silane adhesion promoters with a reactive functional group such as epoxy silanes (e.g., gamma-glycidoxypropyltrimethoxysilane) or mercapto silanes (e.g., gamma-mercaptopropyltrimethoxysilane).

### C. Catalyst

In some embodiments, the adhesive formulation comprises 0.01% to 3% of a catalyst in the first component, the second component, or both components, by weight of the component. The catalyst can promote the reaction of water with the silane-terminated urethane prepolymer. In a further embodiment, the adhesive formulation comprises 0.01% to 1% of a catalyst in the first component, the second component, or both components, by weight of the component; wherein the catalyst promotes the reaction of water with the silane-terminated urethane prepolymer. In a further embodiment, the adhesive formulation comprises 0.2% to 0.5% of a catalyst in the first component, the second component, or both components, by weight of the component; wherein the catalyst promotes the reaction of water with the silane-terminated urethane prepolymer.

Examples of such catalysts include tertiary amine catalysts, organometallic catalysts, such as bismuth catalysts, alkyl tin carboxylates, oxides and tin mercaptides. Specific examples of tertiary amine catalysts include N-methyl morpholine, N-methyl imidazole, triethylenediamine, bis-(2-dimethylaminoethyl)-ether, 1,4-diazabicyclo[2.2.2]octane (DABCO), dimethylcyclohexylamine, dimethylethanolamine, 2,2-dimorpholinyl-diethylether (DMDEE), N,N,N-dimethylaminopropyl hexahydrotriazine, dimethyltetrahydropyrimidine, tetramethylethylenediamine, dimethylcyclohexylamine, 2,2-N,N benzyldimethylamine, dimethylethanol amine, dimethylaminopropyl amine, Penta-dimethyl diethylene triamine, N,N,N′,N′-tetramethyl-1,6-hexanediamine, N,N′,N′-trimethylaminoethylpiperazine, 1,1′-[[3-(dimethylamino)propyl]imino]bispropan-2-ol, 1,3,5-tris[3-(dimethylamino) propyl]hexahydro-1,3,5-triazine, N—N-dimethyldipropylene triamine, N, N,N′-trimethylaminoethylethanolamine, tris-2,4,6-dimethylaminomethyl phenol, and 1,8-Diazabicyclo[5.4.0]undec-7-ene.

If an organometallic catalyst is used, it is any organometallic catalyst capable of catalyzing the reaction of isocyanate with a functional group having at least one reactive hydrogen. Examples include bismuth catalysts, metal carboxylates such as tin carboxylate and zinc carboxylate. Metal alkanoates include stannous octoate, bismuth octoate or bismuth neodecanoate. The organometallic catalyst can be a bismuth catalyst or an organotin catalyst. Examples include dibutyltin dilaurate, dimethyl tin dineodecanoate, dimethyltin mercaptide, dimethyltin carboxylate, dimethyltin dioleate, dimethyltin dithioglycolate, dibutyltin mercaptide, dibutyltin bis(2-ethylhexyl thioglycolate), dibutyltin sulfide, dioctyltin dithioglycolate, dioctyltin mercaptide, dioctyltin dioctoate, dioctyltin dineodecanoate, dioctyltin dilaurate.

### D. Antisettling and Rheology Additives

Up to about 10 wt %, or about 1-10 wt %, or about 2-7 wt %, or about 2-5 wt %, of precipitated calcium carbonate can be added into either component or both components of the formulation, by weight of the component. Without being bound by any theory, it is believed that the addition of the optional precipitated calcium carbonate may improve the anti-settling of the conductive filler. Additionally, rheology additives such as waxy polyester polyols or urea-based rheology additives can be included in either or both components. These additives can be present at up to 10% by weight of the component, e.g., 0.1% to 8%, 0.5% to 6%, or 1% to 4%.

### IV. Methods and Applications

In one embodiment, the process for preparing the adhesive formulation includes providing the first and second components. When provided as a kit, each adhesive component can be co-packaged or packaged separately. When the adhesive is ready to be used to bond substrates together, the components can be mixed, admixed, or blended together which results in a reaction product when the combination of components are cured. One or more additional optional components can be added to the formulation as desired. For example, at least one catalyst or at least one filler may be added to the adhesive formulation in either component before the components are mixed together or after the components are mixed.

While the amount of the components useful in making the reaction product constituting the adhesive formulation can vary, once the first component and the second component are formulated (separately and individually) and the two components are ready for combining to form the reaction product adhesive, the first component and the second component can be mixed at a ratio ranging from 2:1 to 1:2, e.g., 1:1.

In making the components separately and individually, the ingredients can be mixed together in the desired concentrations discussed above at a temperature of from 5° C. to 80° C., e.g., 15° C. to 50° C., or room temperature for example. In one embodiment, the mixing of the ingredients can be carried out under vacuum. The order of mixing is not critical and two or more compounds can be mixed together followed by addition of the remaining ingredients. The adhesive formulation ingredients that make up the components can be mixed together by any known mixing process and equipment.

In another embodiment, the process of bonding two substrates can comprise forming a layer of the adhesive between two substrates, and curing the layer at the to form a cured adhesive bonded to each of the substrates. For example, the process can comprise combining the first component with the second component, forming a layer of the adhesive between two substrates to form an assembly, allowing the adhesive layer to partially cure at room temperature or by applying heat or infrared radiation to a portion of the assembly, and, in a subsequent and separate curing step, completing the cure of the adhesive layer.

The application of the adhesive to the substrates to be adhered together can be carried out by any known equipment such as metering/mixing/dispensing equipment which can apply a predetermined amount of the first component and the second component, in combination (as an adhesive), to selective portions of the substrates. For example, in an automotive manufacturing process, the two components can be provided in two separate containers. The first component can be drawn from one tank and, at the same time, the second components can drawn from another tank and both streams can be combined together using a known static or dynamic mixers as the combined adhesive components are applied to the substrates. The partial curing step can be performed by curing only one or more predetermined, localized portions of the adhesive layer by applying heat only to the one or more predetermined, localized portions of the assembly to produce an adhesive layer having at least partially cured portions and uncured portions, and the uncured portions of the adhesive layer then can be cured in the subsequent and separate curing step.

In one embodiment, the process of adhering at least a first substrate to at least a second substrate can comprise the steps of: (1) contacting the first component and the second component and mixing the components to form a homogeneous adhesive mixture, e.g., at a temperature of 10-40° C. or 20-30° C.; (2) applying the adhesive mixture to at least a portion of the first substrate; (3) contacting a second substrate with the first substrate such that the mixture is disposed between the first and second substrate; and (4) exposing at least a portion of the mixture to heat under conditions such that the mixture partially cures sufficiently such that the first and second substrate are bonded sufficiently, i.e., with a sufficient strength. The process can further comprise a step (5) of heating the two partially cured substrates at a temperature for a time to fully cure the mixture so as to fully bond the two substrates together. The heat can be applied in step (4) by any known heating means such as by infrared heating. The time between steps (4) and (5) can be about 1 hr or more in one embodiment and about 24 hrs or more in another embodiment; and any time in between the above two time periods.

By curing the adhesive composition, a structure is formed comprising two or more substrates bonded together with the cured adhesive based on the curable adhesive formulation where the cured adhesive is disposed between portions of each of the substrates. In one embodiment, the substrates can comprise dissimilar substrates, i.e., substrates of different materials such as metal, glass, plastics, thermoset resins, fiber reinforced plastics, or mixtures thereof.

The adhesive formulation can be used in a variety of applications. Various articles comprising the cured adhesive are contemplated. In on embodiment, the article comprises a battery module that is formed of at least one battery cell and a cooling unit, wherein the battery module is affixed to the cooling unit via the cured adhesive. In a further embodiment, the battery module is part of an electrically driven vehicle.

### EXAMPLES

The following examples further illustrate this disclosure. The scope of the disclosure and claims is not limited by the scope of the following examples.

### I. Materials

The aluminum hydroxide used was a bimodally distributed aluminum trihydroxide (ATH). The properties are listed below:

| Typical analysis | | |
|---|---|---|
| Al(OH)₃-Content | [%] | 99.7 |
| Moisture | [%] | 0.1 |
| Loss of ignition | [%] | 34.6 |
| Particle size | | |
| Laser diffraction | D₁₀ [μm] | 0.5 |
| | D₅₀ [μm] | 8 |
| | D₉₀ [μm] | 80 |
| Sieve analysis | | |
| (>45 μm) | [%] | 35 |
| Specific Surface area | | |
| (BET) | [m²/g] | 1.2 |
| Bulk density | | |
| | [kg/m³] | 550 |
| Oil absorption | | |
| | [ml/100 g] | 12 |
| Whiteness | | |
| Elrepho 457 nm | [%] | 90 |
| Specific conductivity | | |
| | [μS/cm] | 50 |
| Refractive index | | |
| | | 1.58 |
| Mohs hardness | | |
| | | 3 |
| Density | | |
| | [g/cm³] | 2.4 |

The spherical monomodulus aluminum oxide used had 5 and 70 μm particle sizes, respectively. The spherical aluminum oxide was purchased from Sibelco.

The surface modified ground aluminum oxide was purchased from Sibelco and had the following properties.

Granulometric Data and Physical Characteristics

| | | Typical | | | |
|---|---|---|---|---|---|
| | | values | Minimum | Maximum | Method |
| D₅₀ | μm | 0.75 | 0.5 | 0.95 | Sympatec Laser diffraction |
| D₉₀ | μm | 2 | | 3 | Sympatec Laser diffraction |
| D₉₇ | μm | 5.5 | | 8 | Sympatec Laser diffraction |
| SSA | m²/g | 7.5 | 5 | 8.5 | Nitrogen Physisorption (BET) |
| Moisture | % | 0.15 | | 0.3 | ISO-method 787/2 Halogen |
| | | | | | moisture analyser 105° C. |
| LOI | % | 0.8 | 0.7 | 1.3 | 1000° C., 1 hour |

Chemical Analysis (XRF) %

| | | Typical | | |
|---|---|---|---|---|
| | | values | Minimum | Maximum |
| Al₂O₃ | % (m/m) | 98.9 | 98 | 99.8 |
| Na₂O | % (m/m) | 0.08 | | 0.1 |
| Fe₂O₃ | % (m/m) | 0.02 | | 0.03 |
| SiO₂ | % (m/m) | 0.03 | | 0.07 |
| CaO | % (m/m) | 0.02 | | 0.03 |
| MgO | % (m/m) | 0.07 | 0.05 | 0.10 |

The hexadecyltrimethoxysilane was purchased from Evonik.

The epoxy silane was purchased from Momentive. It is an epoxyide functional silane. The chemical structure is Gamma-Glycidoxypropyltrimethoxysilane.

The polyetheramine was a triamine of approximately 3000 molecular weight. It is a clear, almost colorless, liquid product having medium viscosity and very low vapor pressure.

| | | Test |
|---|---|---|
| Property | Specifications | Method* |
| Appearance | Colorless to pale | ST-30.1 |
| | yellow liquid with | |
| | slight haze permitted | |
| Color, Pt-Co | 75 max. | ST-30.12 |
| Primary amine, | 97 min. | ST-5.34 |
| % of total amine | | |
| Total acetylatables, | 0.96-1.06 | ST-31.39 |
| meq/g | | |
| Total amine, meq/g | 0.90-0.98 | ST-5.35 |
| Water, wt % | 0.25 max. | ST-31.35, 6 |

Typical Physical Properties

| | |
|---|---|
| AHEW (Amine hydrogen equivalent wt.), g/eq | 530 |
| Viscosity, cSt, 25° C. (77° F.) | 367 |
| Density, g/ml (lb/gal), 25° C. | 0.996 (8.30) |
| Flash point, PMCC, ° C. (° F.) | 235 (455) |
| Boiling point, ° C. (° F.) | decomposes |
| | before boiling |

Precipitated calcium carbonate was used to improve antisettling properties.

Catalysts used included a dioctyl tin dineodecanoate supplied by Momentive and 33% 1,4-diazabicyclo[2.2.2]octane in dipropylene glycol, purchased from Evonik, as well as a solution of 1,4-Diazabicyclo[2.2.2]octane in propylene glycol, where the diazabicyclooctane is the active compound.

The aminosilane was purchased from Evonik

Rheology additives: CAPA 2201 which is a polyester polyol, RHEBYK-100 or RHEOBYK 7502 which are modified urea waxes.

DBU: 1,8-Diazabicyclo(5.4.0) undec-7-ene

DESMOSEAL 2749: silane terminated polyurethane prepolymer from Evonik.

DESMOSEAL SXP 2749

| | Alphatic | | |
|---|---|---|---|
| | silane- | | |
| | terminated | | |
| Characterization | prepolymer | | |
| Specification | | Unit of | |
| Property | Value | measurement | Method |
| Viscosity (23° C.) | 4,400-5,800 | mPa · s | M014-ISO 3219/A.3 |

Other data*

| | | Unit of | |
|---|---|---|---|
| Property | Value | measurement | Method |
| Density at 20° C. | approx. 1.01 | g/cm³ | DIN 51757 |
| Flash point | approx. 138 | ° C. | DIN EN ISO 2719 |
| Pour point | approx. −27 | ° C. | DIN ISO 3016 |

### II. Methods

### A. Sample Preparation

In each of the Comparative Examples CE1-CE3 and Inventive Examples IE1 and IE2, all components as listed in Table 1 and Table 2 (first liquid components, then solid components) were added in a planetary mixer or dual asymmetric centrifuge, mixed for about 30 minutes under vacuum then transferred into cartridges, pails or drums for storage.

### B. Tests

Press-in Force: The press-in force is measured with a tensiometer (Zwick). The gapfiller material is placed on a metal surface. An aluminum piston with 40 mm diameter is placed on top and the material is compressed to 5 mm (initial position). The material is then compressed to 0.3 mm with 1 mm/s velocity and force deflection curve is recorded. The force (N) at 0.5 mm thickness is then reported in the datatable and considered as the press-in force.

Thermal Conductivity: Thermal conductivity is measured according to ASTM 5470-12, using a TIM tester from ZFW Stuttgart. The measurement was performed in Spaltplus mode between 1.8-1.2 mm thickness. The described thermal interface is considered as Type I (viscous liquids) as described in ASTM 5470-12. The upper contact is heated to ca.40° C. and the lower contact to ca 10° C., resulting in a sample temperature of ca 25° C. The A and B component are mixed with a static mixer when applied from a manual cartridge system.

Gel Permeation Chromatography (GPC): Molecular weight data of the polyurethane prepolymers were measured by gel permeation chromatography (GPC) with a Malvern Viscothek GPC max equipment. Emsure—THF (ACS, Reag. Ph EUR for analysis) was used as an eluent, PLgel MIXED-D (Agilent, 300× 7.5 mm, 5 μm) was used as a column, and MALVERN Viscotek TDA was used as a detector

Lap Shear tests: Aluminum substrates (from Novelis, AA6061 T6 1.92 mm MF noPT no-lub) substrates (140×25 mm, 1.9 mm thick) were used. The substrates were cleaned with isopropanol before use. The thermal interface is applied on one substrates, before the second substrate is joined within 5 minutes. The thickness is adjusted to 1.0 mm, the overlap area is 25 mm×25 mm. The material is cured and rested for 7 days at 23° C., 50% relative humidity before the lap shear tests were performed. The lap shear samples were then mounted in a tensiometer and the lap shear tests were performed as know by somebody skilled in the art, using a pull speed of 10 mm/min. The force deflection curve is monitored and the strength at break is reported as lap shear strength.

Viscosity: Rheology measurements were performed on an Anton Paar MC 302 rheometer with a parallel plate geometry 25 mm diameter plates were used, the gap was fixed at 0.5 mm. The thermal interface material is brought between the two plates and then a shear rate test was performed from 0.001 to 20 1/s and the viscosity at 10 1/s was reported.

Examples are reported below as comparative “CE” and inventive “IE.”

TABLE 1
Adhesive Formulations (Part A)

| | | | | |
|---|---|---|---|---|
| CE1 | CE2 | CE3 | IE1 | IE2 |

Composition (Part A, wt %)

| | | | | | |
|---|---|---|---|---|---|
| DESMOSEAL 2749 STPU prepolymer (w %) | 8 | 10 | 10 | 8 | 10 |
| Hexadecyltrimethoxysilane (w %) | 0.5 | 0.25 | 0.25 | 0.5 | 0.25 |
| Aminosilane (w %) | 1 | 0.5 | 0.5 | 1 | 0.5 |
| Vinyltrimethoxysilane (w %) | 1 | 1.5 | 1.5 | 1 | 1.5 |
| Rheology additive (w %) | 0.15 | 0.5 | 0.5 | 0.15 | 0.5 |
| Tris(2-ethylhexyl)phosphate (w %) | 4.3 | 3.2 | 3.2 | 4.3 | 3.2 |
| Color paste (w %) | 0.05 | 0.05 | 0.05 | 0.05 | 0.05 |
| ATH bimodal (w %) | — | 48 | 48 | — | 48 |
| Spherical aluminum oxide (70 μm) (w %) | 62.5 | 28 | 28 | 62.5 | 28 |
| Spherical aluminum oxide (5 μm) (w %) | 22.5 | 8 | 8 | 22.5 | 8 |

Property (Part A)

| | | | | | |
|---|---|---|---|---|---|
| Viscosity at 10 s/s at 23° C. (Pa · s) | 137 | 415 | 415 | 137 | 415 |

TABLE 2
Adhesive Formulations (Part B)

| | | | | |
|---|---|---|---|---|
| CE1 | CE2 | CE3 | IE1 | IE2 |

Composition (Part B, wt %)

| | | | | | |
|---|---|---|---|---|---|
| Trifunctional polyamine, 3000 MW (w %) | — | 1 | — | 1 | 1 |
| Hexadecyltrimethoxysilane (w %) | 0.3 | — | 1 | 0.3 | 1 |
| Tris(2-ethylhexyl)phosphate (w %) | 6.58 | 9.45 | 9.45 | 5.58 | 8.45 |
| Water (w %) | 0.1 | 0.5 | 0.5 | 0.1 | 0.5 |
| Catalyst (w %) | 1 | 0.3 | 0.3 | 1 | 0.3 |
| Rheology additive (w %) | 0.3 | 0.15 | 0.15 | 0.3 | 0.15 |
| ATH bimodal (w %) | 20 | 47 | 47 | 20 | 47 |
| Spherical aluminum oxide (70 μm) (w %) | 44.5 | 29.3 | 29.3 | 44.5 | 29.3 |
| Spherical aluminum oxide (5 μm) (w %) | 18.02 | 8.6 | 8.6 | 18.02 | 8.6 |
| Surface-modified ground aluminum | 9 | 3.5 | 3.5 | 9 | 3.5 |
| oxide (w %) | | | | | |
| PORTAFIL H5F13 (w %) | 0.2 | 0.2 | 0.2 | 0.2 | 0.2 |

Property (Part B)

| | | | | | |
|---|---|---|---|---|---|
| Viscosity at 10 s/s at 23° C. (Pa · s) | Not | Not | Not | 82 | 103 |
| | mixable | mixable | mixable | | |

### C. Results

The results of the comparative and inventive examples is shown in Table 3 below. The A-component for both the comparative and the inventive examples is based on silane-terminated polyurethane prepolymers (8 and 10%, respectively) in combination with 84-85% fillers (aluminum oxide or mixture of aluminum oxide with aluminum hydroxide).

Comparative example 1 does not comprise the polyetheramine, but it comprises 0.3% hexadecyltrimethoxysilane and 82.5% fillers (20% ATH, 62.5% Alox). The liquid components were mixed, then the fillers were added, and the mixture was mixed for 30 min under vacuum. It was not possible to get a pasteous material as a very poor dispersion was observed, resulting in a granular powder product which is not possible to apply as an adhesive. Comparative example 3 does not comprise a polyetheramine, but it comprises 1% of hexadecyltrimethoxysilane and 84.9% fillers (47% ATH, 37.9% Alox). Comparative example 3 was not possible to mix into a pasteous product as the dispersion was too poor. Comparative example 2 does comprise 1% polyetheramine, but it does not comprise any hexadecyltrimethoxysilane. For comparative example 2, the dispersion was poor and it was not possible to get a pasteous product.

When the B-component included the polyetheramine and the hexadecyltrimethoxysilane, it was possible to get a nice pasteous product with a low viscosity and a high thermal conductivity. The high filler levels in both the A and B components are needed to get a high thermal conductivity of >1.8 W/mK. When a polyethermaine AND an alkyl-silane are mixed into the B-component, the formulations were mixable and offering a low viscosity.

TABLE 3
Results

| | | | | |
|---|---|---|---|---|
| CE1 | CE2 | CE3 | IE1 | IE2 |

Property (Mixture of A & B (1:1 v/v))

| | | | | | |
|---|---|---|---|---|---|
| Thermal Conductivity λ_{eff} | N/A | N/A | N/A | 2.6 | 2.2 |
| (W/mK) | | | | | |
| Viscosity at 10 1/s (Pa · s) | N/A | N/A | N/A | 83 | 355 |
| Squeeze flow (N at 0.35 mm) | N/A | N/A | N/A | 215 | 319 |
| Lap Shear Strenght (MPa) | N/A | N/A | N/A | 1.5 | 1 |
| Lap shear tests-failure mode | N/A | N/A | N/A | 100% | 100% |
| on aluminum | | | | CF | CF |
| Tensile strength (MPa) | N/A | N/A | N/A | 1 | 1 |
| E-modulus (MPa) | N/A | N/A | N/A | 15 | 10 |
| Elongation at break (%) | N/A | N/A | N/A | 8 | 6 |

N/A: not applicable.

N/A: not applicable.

Features and advantages of this disclosure are apparent from the detailed specification, and the claims cover all such features and advantages. Numerous variations will occur to those skilled in the art, and any variations equivalent to those described in this disclosure fall within the scope of this disclosure. Those skilled in the art will appreciate that the conception upon which this disclosure is based may be used as a basis for designing other compositions and methods for carrying out the several purposes of this disclosure. As a result, the claims should not be considered as limited by the description or examples.

1. An uncured, two-part thermally conductive adhesive formulation having:
a) a first component comprising:
i) 1% to 25% of a silane-terminated urethane prepolymer by weight of the first component;
ii) at least 70% of a first thermally conductive filler by weight of the first component;
iii) 0.1% to 5% of a first organofunctional silane by weight of the first component; and
iv) 0% to 10% of a first plasticizer by weight of the first component; and
b) a second component comprising:
i) 0.01% to 5% of water by weight of the second component;
ii) at least 70% of a second thermally conductive filler by weight of the second component;
iii) 0.1% to 5% of a polyetheramine by weight of the second component;
iv) 0.1% to 5% of a second organofunctional silane by weight of the second component; and
v) 1% to 20% of a second plasticizer by weight of the second component;
wherein the uncured adhesive formulation is in the form of a kit in which the first and second components are not mixed.

2. The adhesive formulation of claim 1, wherein the first component comprises 5% to 25% of the silane-terminated urethane prepolymer by weight of the first component.

3. (canceled)

4. (canceled)

5. The adhesive formulation of claim 1, wherein the first and second components independently comprise 70% to 95% of the first and second thermally conductive fillers, respectively, by weight of the component.

6. (canceled)

7. (canceled)

8. The adhesive formulation of claim 1, wherein the first or second thermally conductive filler comprises aluminum trihydroxide, aluminum oxide, or a combination thereof.

9. The adhesive formulation of claim 1, wherein the second component comprises 0.1% to 2% of water by weight of the second component.

10. (canceled)

11. The adhesive formulation of claim 1, wherein the second component comprises 0.5% to 3% of the polyetheramine by weight of the second component.

12. (canceled)

13. The adhesive formulation of claim 1, wherein the polyetheramine has a molecular weight ranging from 200 to 6,000 g/mol.

14. (canceled)

15. (canceled)

16. (canceled)

17. The adhesive formulation of claim 1, wherein the polyetheramine has at least one residue having the formula: 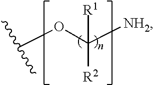
wherein n is an integer ranging from 1 to 5, and R¹ and R² are independently hydrogen or optionally substituted C1-C4 alkyl.

18. The adhesive formulation of claim 1, wherein the polyetheramine has the structure: 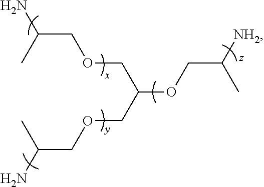
wherein x, y, and z total an integer ranging from 6 to 90.

19. The adhesive formulation of claim 1, wherein the first and second components independently comprise 0.5% to 3% of the first and second organofunctional silanes, respectively, by weight of the component.

20. (canceled)

21. The adhesive formulation of claim 1, wherein the first or second organofunctional silane is an alkyl silane.

22. The adhesive formulation of claim 1, wherein the first or second organofunctional silane has the following structure: 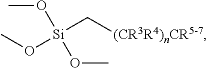
wherein n is an integer ranging from 0 to 24 and R³-R⁷ are independently hydrogen or optionally substituted C1-C4 alkyl.

23. The adhesive formulation of claim 1, wherein the first component comprises 1% to 8% of the first plasticizer by weight of the first component.

24. (canceled)

25. The adhesive formulation of claim 1, wherein the second component comprises 3% to 15% of the second plasticizer by weight of the second component.

26. (canceled)

27. The adhesive formulation of claim 1, wherein the first plasticizer, when present, or the second plasticizer, has the following structure: 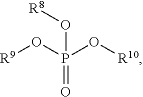
wherein R⁸-R¹⁰ are independently optionally substituted branched or linear C1-C24 alkyl.

28. The adhesive formulation of claim 1, further comprising 0.1% to 3% of an adhesion promoter in the first component, the second component, or both components, by weight of the component.

29. (canceled)

30. (canceled)

31. The adhesive formulation of claim 1, wherein the adhesion promoter comprises an aminosilane, an epoxysilane, or a combination thereof.

32. The adhesive formulation of claim 1, further comprising 0.01% to 3% of a catalyst in the first component, the second component, or both components, by weight of the component; wherein the catalyst promotes the reaction of water with the silane-terminated urethane prepolymer.

33-45. (canceled)
